(19) United States
(12) Patent Application Publication
(10) Pub. No.: US 2002/0149837 A1
(43) Pub. Date: Oct. 17, 2002

(54) Optical attenuation module, optical amplifier using the module, and pump light source

(75) Inventor: Tokushi Sekimura, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 10/121,843

(22) Filed: Apr. 15, 2002

(30) Foreign Application Priority Data
Apr. 13, 2001 (JP) 2001-115927
Oct. 31, 2001 (JP) 2001-334903

(51) Int. Cl. H01S 3/00

(52) U.S. Cl. 359/333

(57) ABSTRACT

A plurality of optical attenuators are connected in series between a light input end and a light output end. Light attenuations capacities of the optical attenuators increase successively from the light input end towards the light output end. The optical attenuators attenuate an input light, but in this instance, light consumption power by the respective optical attenuators are almost equalized.

### FIELD OF THE INVENTION

The present invention relates to an optical attenuation module, an optical amplifier using the module, and a pump light source.

### BACKGROUND OF THE INVENTION

Optical communication equipment has been remarkably advanced in recent years and thereby, an optical-fiber amplifier which obtains a high output of 1 W and an exciting laser diode are also developed. When measuring characteristics of the high-output optical device or optical equipment, a light output of the device or equipment, for example, is measured by measuring the quantity of heat of the light emitted from the optical device or optical equipment. However, to measure the wavelength characteristic, gain, or noise factor and the like of the above optical device or optical equipment and the like, it is necessary to attenuate them up to a level allowed by a measuring instrument which measures the above light output.

The maximum input allowable level of light of this type of the measuring instrument is approx. 10 mW (10 dBm). When considering the linearity of a measuring level of this measuring instrument, it is preferable to use the instrument in a range of 1 mW (0 dBm) to 0.1 mW (−10 dBm). Therefore, to measure the above characteristic of the light having a high output of 1 W, it is necessary to greatly attenuate it by approx. 30 dB.

The light to be guided to a measuring instrument through an optical fiber is attenuated by setting an optical attenuator in the middle of an optical transmission line formed by the optical fiber. In this instance, the light is attenuated by selecting an optical attenuator corresponding to a desired attenuation out of a plurality of optical attenuators having various optical attenuations and setting the selected optical attenuator in the middle of the above optical transmission line.

However, when selecting an optical attenuator by watching only the attenuation, there is a problem that an overload is applied to the optical attenuator due to the heat produced by attenuation of a light output when high-output light is input to the selected optical attenuator and the optical attenuator is broken. That is, because the optical attenuator itself has a maximum input allowable level, the maximum input allowable level usually lowers as an attenuation increases. Therefore, to greatly attenuate high-output light by one optical attenuator, a problem occurs that the heat produced due to the attenuation action of a light output is excessively increased by the attenuator and the attenuator is broken due to the heat produced.

Moreover, monitoring the signal light amplified by an optical amplifier and the pump light emitted from a pump light source used for the optical amplifier is indispensable for control of a light output, output of an alarm, and monitoring of a light level and the like. An optical amplifier is developed up to a level at which signal light of 1 W can be output at present. For example, with some of Raman optical amplifiers, output of the pump light output from a pump light source exceeds 1 W. To monitor the signal light output from an optical amplifier and pump light used for an optical amplifier, the signal light and pump light are branched by an optical branching unit and the branched light outputs are detected by a photodetector (PD).

However, to monitor high-output light, there is a problem that a PD may not accurately operate due to saturation of the photo-detection level of the PD. Moreover, when a photo-detection level extremely exceeds an allowable photo-detection level, there is a problem that a PD may be broken. Furthermore, oscillation and the like may occur in an optical circuit due to the light reflected from a PD. When any one of these problems occur, there is a problem that it is impossible to realize accurate monitoring and finally deteriorate the function of an optical amplifier.

### SUMMARY OF THE INVENTION

It is an object of the present invention to provide an optical attenuation module capable of measuring characteristics of a high-output optical device and an optical equipment or stably attenuating high-output light when monitoring and controlling an optical transmission system including a pump light source and an optical amplifier and raising the apparent maximum photo-detection level of a photodetector, an optical amplifier using the module, and a pump light source.

According to one aspect of the invention, there is provided an optical attenuation module having a light input end and a light output end. Light input from the light input end is attenuated to a predetermined optical power and the attenuated light is output from the light output end. The optical attenuation module comprises a plurality of optical attenuators provided in between the light input end and the light output end. Each of the optical attenuators attenuates the input light by a predetermined optical attenuation, and the optical attenuation of each of the optical attenuators is set to a value so that the optical attenuator is not damaged by light consumption power consumed within each of the optical attenuators.

According to another aspect of the present invention, there is provided an optical attenuation module having a light input end and a light output end. Light input from the light input end is attenuated to a predetermined optical power and the attenuated light is output from the light output end. The optical attenuation module comprises an optical attenuator in which the optical attenuation per unit length is successively increased from the light input end toward the light output end.

According to still another aspect of the present invention, there is provided an optical attenuation module having a pair of light input/output ends to apply predetermined attenuation to the light input from one of the light input/output ends and output the attenuated light from the other light input/output end. The optical attenuation module comprises a plurality of optical attenuators connected in series between the pair of light input/output ends. In the optical attenuator connected to the vicinity of the former light input/output end, an optical attenuation is set to a value relatively lower than that of the other serially connected optical attenuators.

According to still another aspect of the present invention, there is provided an optical attenuation module having a pair of light input/output ends to apply predetermined attenuation to the light input from one of the light input/output ends and output the attenuated light from the other light input/output end. The optical attenuation module comprises an optical attenuator in which an optical attenuation per unit length is successively increased from the former light input/output end up to the vicinity of the middle between the pair of light input/output ends and an optical attenuation per unit length is successively decreased from the vicinity of the middle up to the other light input/output end.

According to still another aspect of the present invention, there is provided an optical amplifier comprising a pump light source, an amplifying optical fiber, a control circuit, a light-monitoring optical branching unit, a light-monitoring photodetector, and an optical attenuator provided between the optical branching unit and the photodetector.

According to still another aspect of the present invention, there is provided a pump light source comprising alight source, a control circuit, alight-monitoring optical branching unit, a light-monitoring photodetector, and an optical attenuator provided between the optical branching unit and the photodetector.

Other objects and features of this invention will become apparent from the following description with reference to the accompanying drawings.

### BRIEF DESCRIPTION OF THE DRAWINGS

FIG. 1 is a plane view which shows a configuration including a local rupture of an optical attenuation module of a first embodiment of the present invention,

FIG. 2 is an illustration which shows a connection state of an optical attenuator in the optical attenuation module shown in FIG. 1,

FIG. 3 is an assembly drawing which shows a set state of an optical attenuator in the optical attenuation module shown in FIG. 1,

FIG. 4 is a graph which shows the relation of a light attenuation to a connection sequence of an optical attenuator,

FIG. 5 is a graph which shows the relation of light consumption power to a connection sequence of an optical attenuator,

FIG. 6 is a graph which shows the relation of a light attenuation to a connection sequence of an optical attenuator in an optical attenuation module of a second embodiment of the present invention,

FIG. 7 is a chart which shows the relation between light output and light attenuation of each optical attenuator to a connection sequence of optical attenuators of an optical attenuation module of the second embodiment of the present invention,

FIG. 8 is a graph which shows the relation of light consumption power for every light input direction in each optical attenuator,

FIG. 9 is a graph which shows the relation of synthetic-light consumption power for every light input direction in each optical attenuator,

FIG. 10 is an illustration which shows connection states of a plurality of optical attenuators using optical attenuation fibers having the same dopant ratio,

FIG. 11 is an illustration which shows connection states of a plurality of optical attenuators using optical attenuation fibers having different dopant ratios,

FIG. 12 is an illustration which shows an optical attenuator using an optical attenuation fiber in which a dopant ratio is continuously changed,

FIG. 13 is a perspective view of an optical attenuation module which shows a state when an optical attenuator is housed in a heat radiating case,

FIG. 14 is a perspective view of an optical attenuation module which shows a state when radiating fins are set to a heat radiating case,

FIG. 15 is a perspective view of an optical attenuation module which shows a state when a liquid-cooled unit using a heat pipe is set to a heat radiating case,

FIG. 16 is a perspective view of an optical attenuation module which shows a state when an air-cooled unit using an air-cooling fan is set to a heat radiating case,

FIG. 17 is a perspective view of an optical attenuation module which shows a state when airholes are formed on a heat radiating case,

FIG. 18 is a perspective view which shows a radiating plate to be set to a V-groove chip,

FIG. 19 is a perspective view which shows a set state of a heat-conductive sheet to be set between a V-groove chip and a pressing plate,

FIG. 20 is a block diagram which shows a configuration of an optical amplifier which is a forth embodiment of the present invention,

FIGS. 21A to 21D are graphs which show attenuation distributions of the optical attenuation module shown in FIG. 20,

FIG. 22 is a block diagram which shows a part of the configuration of an optical amplifier which is a fifth embodiment of the present invention,

FIG. 23 is a block diagram which shows a part of the local configuration of an optical amplifier which is a sixth embodiment of the present invention,

FIG. 24 is a block diagram showing a partial modification of the structure of the optical amplifier shown in FIG. 23,

FIG. 25 is a plan view showing an example of a PLC coupler,

FIG. 26 is a diagram showing a multistage structure of the optical branching unit shown in FIG. 23,

FIG. 27 is a block diagram showing the structure of the pump light source (optical pump unit) which is the sixth embodiment,

FIG. 28 is a diagram showing how the optical pump unit shown in FIG. 27 is connected to a fiber for amplification,

FIG. 29 is a block diagram showing a modification of the optical pump unit shown in FIG. 28,

FIG. 30 is an assembly drawing which shows the internal structure of the optical pump unit shown in FIG. 27,

FIG. 31 is an assembly drawing which shows a state of setting a heat sink to the housing of the optical pump unit,

FIG. 32 is an assembly drawing which shows a state of setting a cooling fan unit to the housing of the optical pump unit, and

FIG. 33 is an assembly drawing which shows a state of setting a liquid-cooled unit to the housing of the optical pump unit.

### DETAILED DESCRIPTION

The present invention relates to an optical attenuation module capable of measuring characteristics of a high-output optical device or an optical equipment or stably attenuating high-output light when monitoring and controlling an optical transmission system including an a pump light source and an optical amplifier and raising the apparent maximum photo-detection level of a photodetector, an optical amplifier using the module and a pump light source.

The present invention is described below in detail by referring to the accompanying drawings.

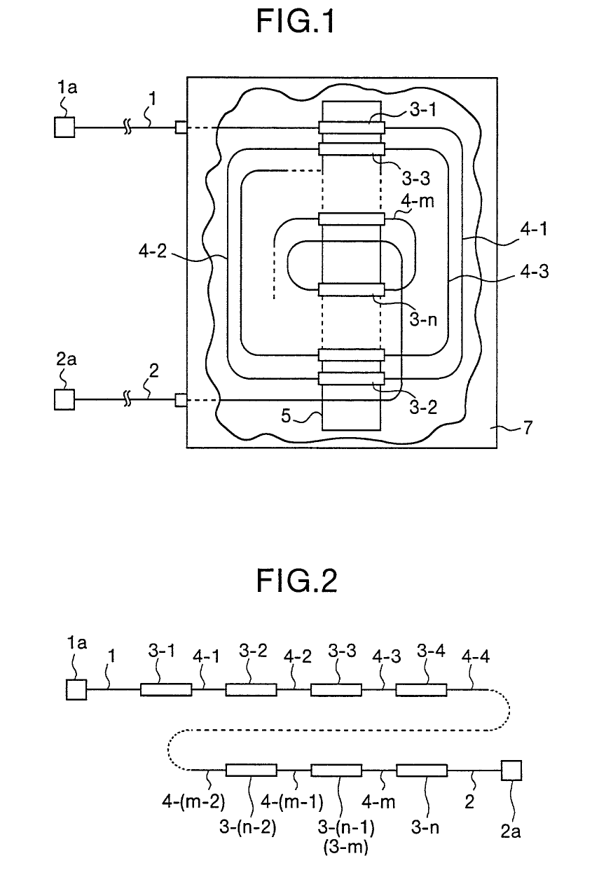

A first embodiment of the present invention is described below. FIG. 1 is a locally-cutaway plane view which shows a schematic configuration of the optical attenuation module which is the first embodiment of the present invention. In FIG. 1, a connector-provided optical fiber 1 having a connector 1a forms a light input end and a connector-provided optical fiber 2 having a connector 2a forms a light output end. N attenuators 3-1 to 3-n are successively connected to each other in series as shown in FIG. 2 and set between the connector-provided optical fibers 1 and 2. The optical attenuators 3-1 to 3-n are connected to each other by m (m=n−1) optical fibers 4-1 to 4-m. That is, the respective optical fibers 1, 4-1 to 4-m and 2 are connected to both ends of the optical attenuators 3-1 to 3-m respectively to connect the optical attenuators 3-1 to 3-n in series. The optical attenuators 3-1 to 3-n are respectively provided with a pair of darkening plates set so as to be opposite to each other between a pair of collimator lenses serving as a light input/output section to attenuate light.

It is also allowed to form a structure of fusion splicing with fiber displacement and assemble optical attenuators. When making the optical attenuators 3-1 to 3-n, optical fibers (1, 4-1 to 4-n and 2 in order) are aligned facing each other with slight displacement to have predetermined coupling loss to be spliced. When it is made so, the optical attenuator 3-1 to 3-n can simplify the structure of the overall optical attenuation module by making it such that it is the structure of fusion splicing with fiber displacement.

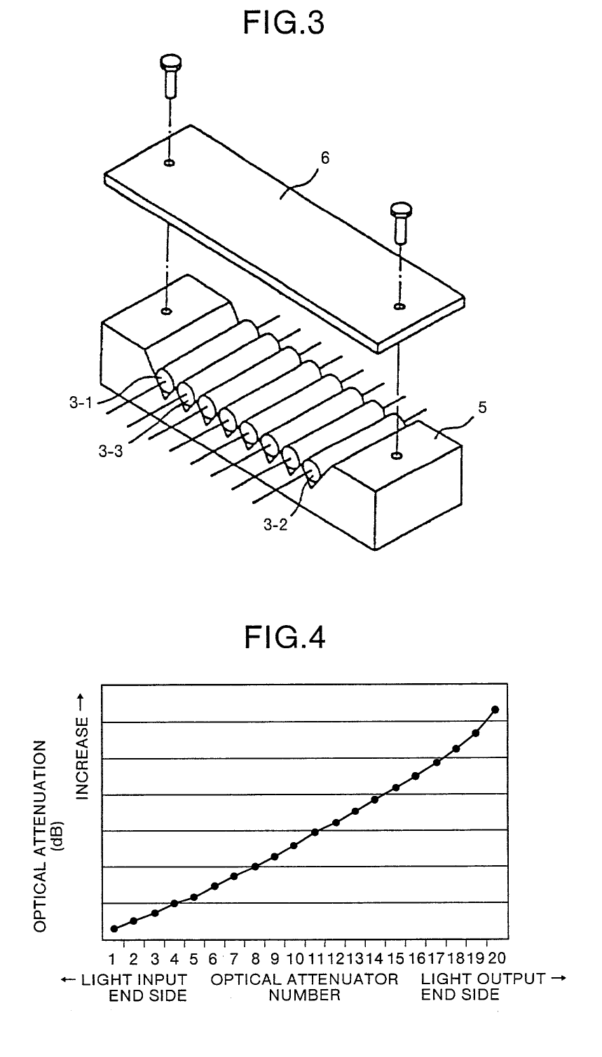

In this instance, as shown in FIG. 3, the optical attenuators 3-1 to 3-n are arranged and set on a V-groove chip 5 in which a plurality of V-grooves are formed in parallel, fixed by a pressing plate 6, and housed in a boxy radiating case 7. The V-groove chip 5 and pressing plate 6 transfer the heat produced due to the attenuation action of light outputs by the optical attenuators 3-1 to 3-n to the heat radiating case 7 and thermally and mechanically stably hold the optical attenuators 3-1 to 3-n. The heat radiating case 7 radiates the heat produced in the optical attenuators 3-1 to 3-n to the outside to eliminate thermal loads from the optical attenuators 3-1 to 3-n. Moreover, the heat radiating case 7 has a function for intercepting the light leaking from the optical attenuators 3-1 to 3-n.

Here, the optical attenuators 3-1 to 3-n connected in series are arranged so that attenuations of the attenuators 3-1 to 3-n successively increase from the connector-provided optical fiber 1 functioning as a light input end toward the connector-provided optical fiber 2 serving as a light output end. Moreover, light power consumed by the optical attenuators 3-1 to 3-n are almost equalized and the heat produced by the optical attenuators 3-1 to 3-n is averaged to disperse thermal loads.

For example, when the optical attenuators 3-1 to 3-n are 20 and optical attenuator numbers “1” to “20” are related to the optical attenuators 3-1 to 3-20, the light attenuation of the optical attenuator 3-1 (optical attenuator No. 1) connected to the connector-provided optical fiber 1 is set to a minimum value and the light attenuation of the optical attenuator 3-20 (optical attenuator No. 20) is set to a maximum value so that the desired whole attenuation of the optical attenuators of optical attenuator Nos. 1 to 20 connected in series is obtained. Moreover, a not-illustrated high-output optical device or optical equipment is connected to the connector 1a of the connector-provided optical fiber 1 and a not-illustrated measuring instrument is connected to the connector-provided optical fiber 2.

Here, light attenuations of the optical attenuators 3-1 to 3-20 are set so as to be successively increased toward the light output end but optical power input to the optical attenuators 3-1 to 3-20 are successively decreased toward the light output end. As a result, light consumption power (mW) consumed by the optical attenuators 3-1 to 3-20 can be almost equalized with the optical attenuators 3-1 to 3-20. Thereby, thermal loads for the optical attenuators 3-1 to 3-20 are almost equalized with each other, thereby quantities of heat produced by the optical attenuators 3-1 to 3-20 are almost equalized with each other, and dispersion of thermal loads is achieved. As a result, thermal design of an optical attenuation module is simplified and it is also prevented that the optical attenuators 3-1 to 3-20 are thermally broken. Moreover, with the optical attenuators 3-1 to 3-20, because the maximum input allowable level of received light can be lowered compared to when it is of one optical attenuator configuration, it is possible to reduce the cost for manufacturing an optical attenuation module.

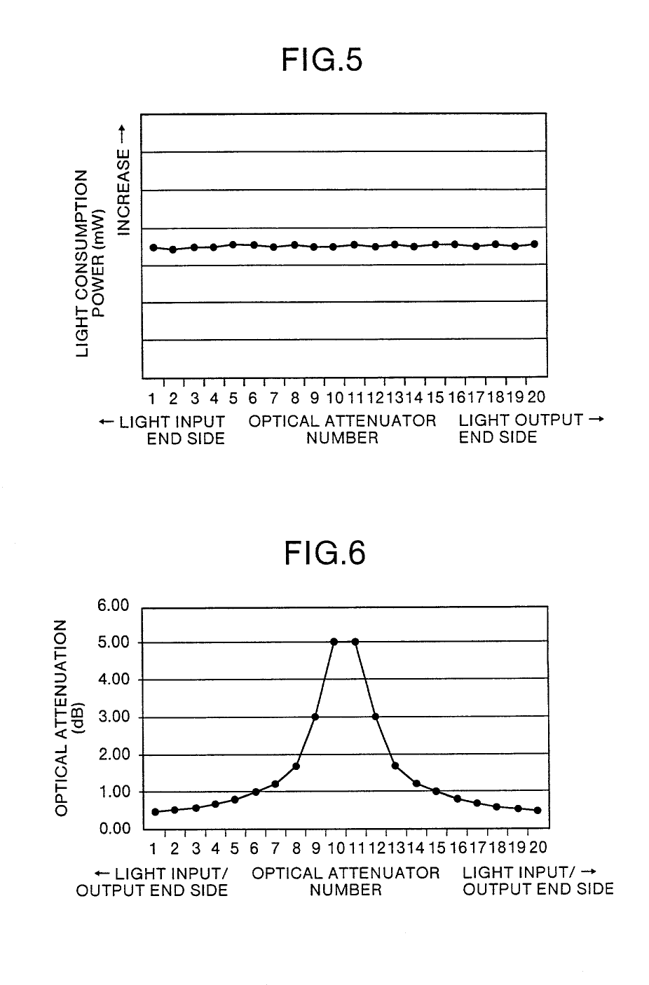

In FIG. 5, light consumption power of the optical attenuators 3-1 to 3-20 are set so as to be almost equalized with each other. However, it is not so limited and it is also allowed to set a light attenuation so as to increase the light consumption power of some of the optical attenuators 3-1 to 3-20 corresponding to a place having a high radiation characteristic in view of thermal design of an optical attenuation module. Moreover, when the optical attenuators 3-1 to 3-n are arranged in parallel, because the radiation characteristic is reduced at the central portion, it is allowed to set light consumption power of optical attenuators arranged at the central portion so as to be smaller than the light consumption power of optical attenuators arranged at the circumferential portion.

Moreover, though optical attenuators are connected in series in the above first embodiment, it is not so limited and it is also allowed to connect a series of optical attenuators connected in series in parallel. Thereby, it is possible to further disperse the light consumption power.

Furthermore, in the first embodiment, each optical attenuator continuously changes light attenuations. However, it is not so limited and it is also allowed to stepwise change attenuations every two or three optical attenuators having the same light attenuation. In this instance, because optical attenuators having the same light attenuation can be used, it is possible to simplify configurations and reduce costs.

A second embodiment of the present invention is described below. Though the light input to the optical attenuators 3-1 to 3-n is unidirectional in the above first embodiment, the second embodiment purposes an optical attenuation module in which light is bidirectionally input and output.

Though the optical attenuation module of the second embodiment has the same configuration as the first embodiment, connectors 1a and 2a of connector-provided optical fibers 1 and 2 respectively function as a light input/output end. That is, light is transmitted from the connector 1a to the connector 2a and vice versa and attenuated in each direction.

As shown in FIG. 6, in the second embodiment, light attenuations of optical attenuators 3-1 to 3-20 are set so as to successively decrease from optical attenuators 3-10 and 3-11 (optical attenuator Nos. 10 and 11) set in the middle toward the optical attenuators 3-1 and 3-20 (optical attenuator Nos. 1 and 20) set at each of the light input/output end. That is, the attenuations of the optical attenuators 3-1 to 3-10 connected in series are stepwise set so that attenuations of the optical attenuators 3-1 and 3-20 at the both sides are minimized and those of the optical attenuators 3-10 and 3-11 located at the inside middle are maximized and a symmetric shape is formed between a pair of connector-provided optical fibers 1 and 2 and successively changed.

Specifically, when a specification of attenuating the light having a wavelength of 1,550 nm and an output of 1 W (e.g. laser beam) up to 1 mW is provided, the whole attenuation of an optical attenuation module is set to 30 dB. Then, when assuming the number of optical attenuators 3-1 to 3-n to be set in the optical attenuation module as 20, attenuations of the optical attenuators 3-1 to 3-20 are set so that light is attenuated by 10 dB in the total of nine optical attenuators 3-1 to 3-9 from the optical attenuator 3-1 up to the optical attenuator 3-9 at the connector-provided optical fiber-1 side, light is attenuated by 10 dB in the total of two optical attenuators 3-10 and 3-11 located at the middle, and light is attenuated by 10 dB in the total of nine optical attenuators 3-12 to 3-20 from the optical attenuator 3-12 up to the optical attenuator 3-20.

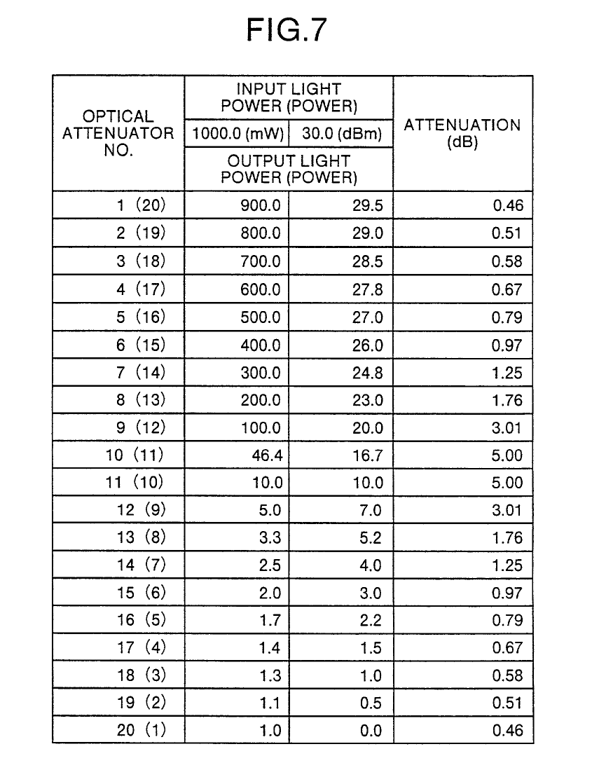

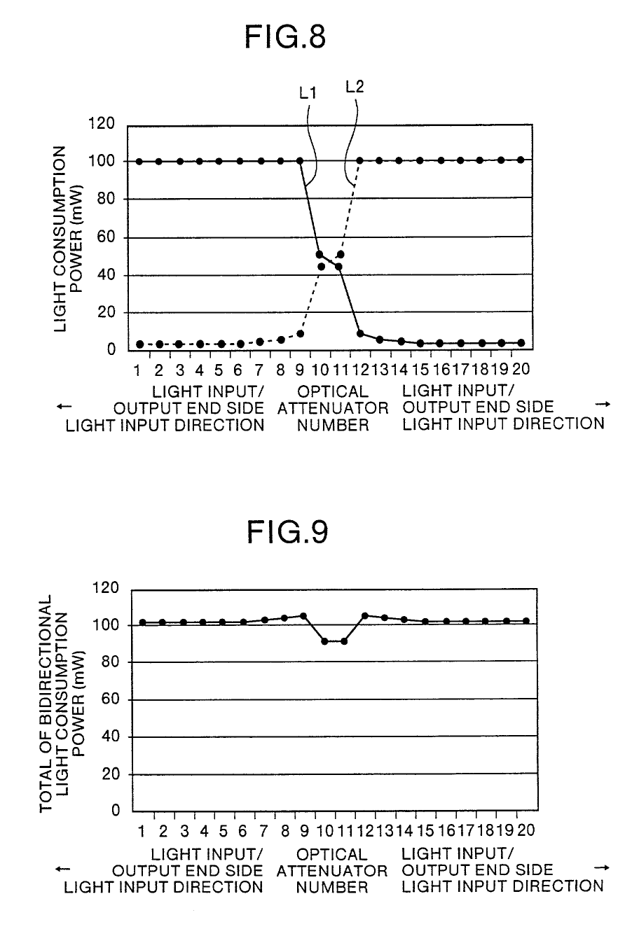

Particularly, when assuming that attenuations of the optical attenuators 3-1 to 3-n are stepwise changed by forming an angular symmetric shape between the pair of connector-provided optical fibers 1 and 2 and the light of 1 W is successively attenuated every 100 mW in the total of nine optical attenuators from 3-1 up to 3-9, attenuations of these optical attenuators 3-1 to 3-20 connected in series are set as shown in FIG. 7. FIG. 8 is a graph in which the attenuations are graphed as light consumption power of the optical attenuators 3-1 to 3-20.

That is, attenuations of the plurality of optical attenuators 3-1 to 3-20 connected in series are stepwise increased for every optical attenuator successively located from the optical attenuators 3-1 and 3-20 (optical attenuator Nos. 1 and 20) at the pair of light input/output end side toward the central side. Specifically, [0.46 dB], [0.51 dB], [0.58 dB], . . . , and [5.00 dB] are set from the optical attenuators 3-1 and 3-20 toward the optical attenuators 3-10 and 3-11. Moreover, even when the light of 1 W is input from any one of a pair of light input/output-end sides, the light is attenuated every 100 mW by the input-side nine optical attenuators 3-1 to 3-9 or the optical attenuators 3-20 to 3-12 and attenuated up to the total of 10 dB.

In this instance, light consumption power of the optical attenuators 3-1 to 3-10 in total of the bidirectional light input/output are described below. FIG. 9 shows light consumption power of the optical attenuators 3-1 to 3-20 obtained by adding light consumption power L1 to a light input from the connector-provided optical fiber 1 toward the connector-provided optical fiber 2 and light consumption power L2 to a light input from the connector-provided optical fiber 2 toward the connector-provided optical fiber 1. The added light consumption power are respectively close to approx. 100 mW to the optical attenuators 3-1 to 3-20 and thereby, thermal loads are dispersed and thermal breakdown is prevented. In this instance, because there is no optical-transfer directivity, there occurs no connection error to alight source or a measuring instrument and thereby, handling of then becomes easy.

A third embodiment of the present invention is described below. In the above first and second embodiments, each of the optical attenuators 3-1 to 3-n attenuates light by a light intercepting plate or the axial shift of an optical fiber. In the third embodiment, however, optical attenuators 3-1 to 3-n are respectively formed by an optical attenuation fiber to which a dopant such as an organic metallic compound containing transition-metal ions or a rare-earth element is added.

An optical attenuation fiber attenuates light by the fact that the light in a predetermined wavelength area is absorbed by using an organic metallic compound containing one or more types of transition-metal ions selected out of cobalt (Co), chromium (Cr), copper (Cu), zinc (Zn), lead (Pb), iron (Fu), aluminum (Al), nickel (Ni), manganese (Mn), and vanadium (V) or a rare-earth element such as samarium (Sm), thulium (Tm), or praseodymium (Pr) as a dopant and adding the dopant to either or both of a core portion 9a and clad portion 9b of an optical fiber. Organic metallic compounds include CoO, NiO, COCl₂, and Co(NO₃)₂. Moreover, rare-earth elements include all rare-earth elements.

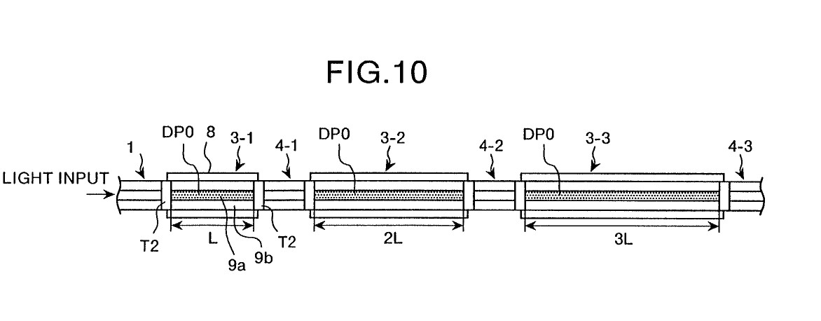

As shown in FIG. 10, an optical attenuation fiber such as an optical attenuation fiber 3-1 is constituted by connecting both ends of a fiber doped with a dopant to the core portion 9a by optical connectors T1 and T2 and housing them in a casing 8. With the optical attenuation fiber 3-1, an optical fiber 1 is connected to the optical connector-T1 side and an optical fiber 4-1 is connected to the optical connector-T2 side.

In this instance, when types of dopants are the same and doping quantities are the same, it is possible to set a light attenuation in accordance with the length of a fiber. Therefore, as shown in FIG. 10, by using cobalt as a dopant and successively increasing the length of an optical attenuation fiber at the same dopant ratio DP0, it is possible to successively increase light attenuations of the optical attenuators 3-1 to 3-3. For example, when the optical attenuators 3-1 to 3-3 have lengths of L, 2L, and 3L respectively and the light attenuation of the optical attenuator 3-1 is 1 dB, light attenuations of the optical attenuators 3-2 and 3-3 become 2 dB and 3 dB respectively. Therefore, by properly and successively increasing lengths of optical attenuation fibers of the optical attenuators 3-1 to 3-n shown in FIG. 4 and connecting them in series, it is possible to easily set light attenuations of the optical attenuators 3-1 to 3-n described in the first embodiment. Similarly, by successively increasing lengths of optical attenuation fibers from both ends and connecting them in series, it is possible to easily set light attenuations of the optical attenuators 3-1 to 3-n described in the second embodiment.

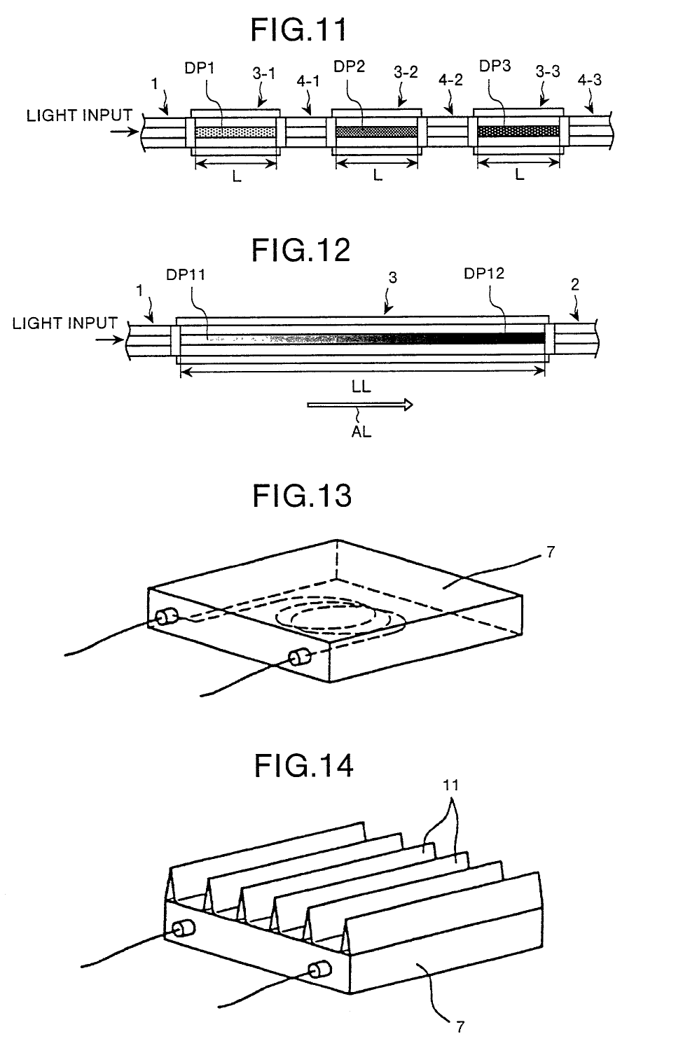

Moreover, it is allowed to set light attenuations to optical attenuation fibers by using the same dopant and changing a dopant ratio. This is because a change of light attenuations corresponds to a change of doping quantities when the same type of light absorbing fibers is used. For example, as shown in FIG. 11, by setting all optical attenuation fibers to the same length L and successively increasing doping quantities DP1 to DP3 of metals to be doped to the optical attenuators 3-1 to 3-3, it is possible to successively increase light attenuations of the optical attenuators 3-1 to 3-3. For example, by setting dopant ratio DP2 and DP3 of the fibers of optical attenuators 3-2 and 3-3 to the predetermined value which is obtained as a function of attenuation, it is possible to set the optical attenuators 3-2 and 3-3 to preferable light attenuation values. In this instance, because all optical attenuators 3-1 to 3-n can be set to the same length L, it is possible to realize a compact optical attenuation module.

Moreover, it is allowed to continuously form the above optical attenuation fibers and realize the optical attenuators 3-1 to 3-n as an optical attenuator 3. That is, as shown in FIG. 12, doping quantities are continuously increased toward the light input direction AL so that they become equal to doping quantities DP11 to DP12. In this instance, it is possible to almost equalize the light consumption power per unit of the optical attenuator 3 serving as an optical attenuation fiber, the thermal load is dispersed, and moreover thermal breakdown is prevented. Moreover, because it is unnecessary to connect optical attenuators 3-1 to 3-n with each other by optical fibers 4-1 to 4-m, it is easy to fabricate an optical attenuation module.

The optical attenuator 3 shown in FIG. 12 is a single optical attenuator. However, it is also allowed to apply the optical attenuator 3 to the optical attenuators 3-1 to 3-n. That is, it is allowed to disperse thermal loads of the optical attenuators 3-1 to 3-n itself per unit length.

Moreover, with an optical attenuation fiber, because a light absorbing fiber is doped to the core portion or clad portion of an optical fiber, it is possible to use the optical attenuation modules described in the above first to third embodiments as optical termination units. Of course, the same can be applied to the optical attenuators 3-1 to 3-n to attenuate light by a light intercepting plate or the axial shift of an optical fiber.

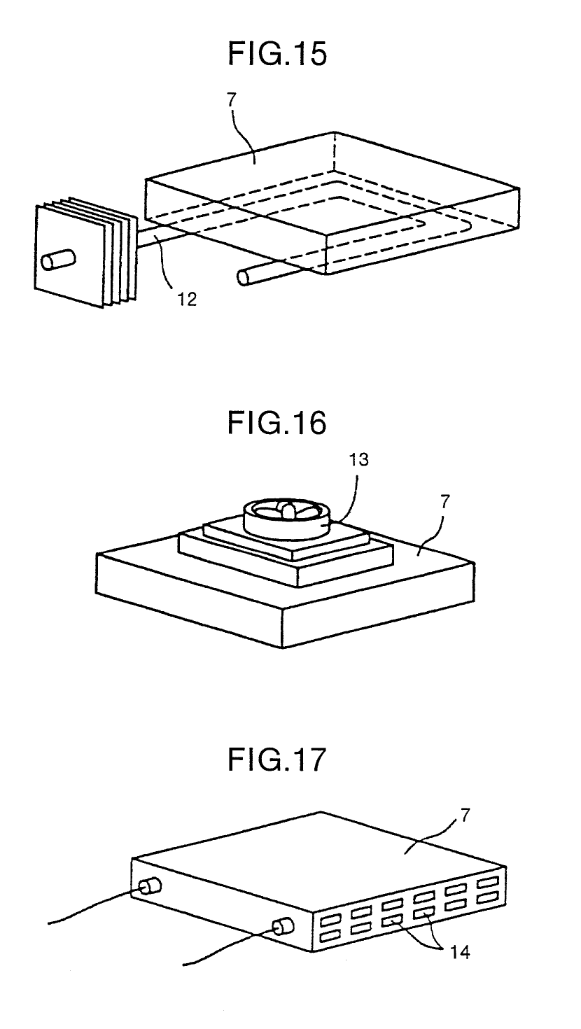

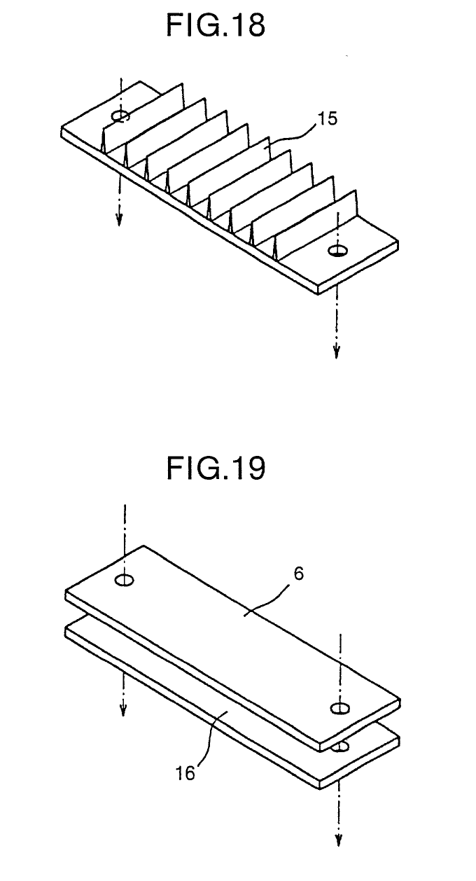

When forming the optical attenuation modules having the structures described in the above first to third embodiments, it is preferable to seal an inert gas in a heat radiating case 7 and improve the heat transfer efficiency from the optical attenuators 3-1 to 3-n to the heat radiating case 7. Moreover, it is preferable to use the whole of the heat radiating case 7 as a heat radiation surface as shown in FIG. 13 or set a radiating fin 11 to the heat radiating case 7 so as to improve the radiation effect as shown in FIG. 14. Moreover, it is effective to set a heat pipe 12 into the heat radiating case 7 to improve the radiation efficiency as shown in FIG. 15 or set an air-cooling fan 13 into the heat radiating case 7 as shown in FIG. 16. Furthermore, it is allowed to forcibly cool the optical attenuator3byaPeltierdevice. Furthermore, when an inert gas is not sealed in the heat radiating case 7, it is also effective to form an airhole 14 on the heat radiating case 7 as shown in FIG. 17 so as to improve the air-cooling effect for the optical attenuators 3-1 to 3-n housed in the heat radiating case 7. In this instance, however, it is necessary to take an action for light interception so that light from the optical fiber is prevented from coming out from the heat radiating case 7 through the airhole 14.

Moreover, it is effective to use a radiating plate 15 as a pressing member instead of a pressing plate 6 which holds the optical attenuators 3-1 to 3-n arranged on a V-groove chip 5 as shown in FIG. 18. Moreover, as shown in FIG. 19, it is effective to set a heat conductive sheet 16 such as a silicon sheet between the pressing plate 6 and the optical attenuators 3-1 to 3-n, thereby improve the heat transfer efficiency of the pressing plate 6 from the optical attenuators 3-1 to 3-n, and improve the cooling efficiency.

Furthermore, it is preferable to prevent the distribution of the heat produced by the optical attenuators 3-1 to 3-n arranged on the V-groove chip 5 from deviating by successively alternately arranging the optical attenuators 3-1 to 3-n from the both ends of the V-groove chip 5 toward the inside of it as shown in FIG. 1. For example, as previously described, to arrange 20 optical attenuators 3 on the V-groove chip 5 in a line, it is allowed to set these optical attenuators 3 in accordance with their numbers so that the numbers are arranged like [1], [19], [3], [17], . . . , [11], [10], . . . , [4], [18], [2], and [20] and the optical attenuators 3 at either side classified by using the central portion as a boundary are dispersedly arranged over the entire width of the V-groove chip 5. Moreover, it is preferable to realize various improvements in order to efficiently cool the optical attenuators 3-1 to 3-n.

The present invention is not limited to the above embodiments. For example, it is allowed to decide the number of optical attenuators 3-1 to 3-n used by connecting them in series or attenuations of the optical attenuators 3-1 to 3-n in accordance with a specification. Moreover, it is possible to use not only the above optical attenuators 3-1 to 3-n but also attenuation films superior in durability and heat resistance embedded onto the cross-sectional surface of an optical fiber. Furthermore, it is, of course, possible to use a plurality of different types of optical attenuators by combining them. Particularly for patterns of change of attenuations to be stepwise set to the optical attenuators 3-1 to 3-n, it is possible to decide attenuations of the optical attenuators 3-1 to 3-n at either side classified by using the central portion as a boundary so that thermal loads of the optical attenuators become almost equal to each other. Furthermore, various modifications of the present invention are allowed as long as they are not deviated from the gist of the present invention.

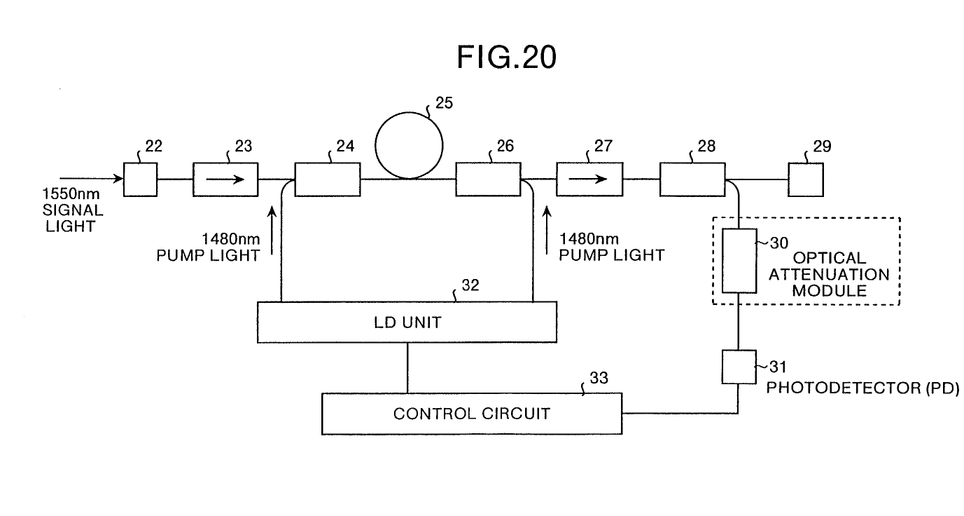

A forth embodiment of the present invention is described below. In the forth embodiment, an optical amplifier to which one of the optical attenuation modules of the first to third embodiments is applied is described. FIG. 20 is a block diagram which shows a configuration of the optical amplifier which is the forth embodiment of the present invention to which one of the optical attenuation modules described in the first to third embodiments is applied. The optical amplifier shown in FIG. 20 is an optical amplifier (EDFA) unit using an erbium-doped fiber. The optical amplifier has an input connector 22 which inputs signal light, a first isolator 23 which intercepts the return light of a light signal input to the input connector 22, an erbium-doped fiber (EDF) 25 for amplifying the input light signal, an LD unit 32 which excites the EDF 25, an optical wavelength-division multiplexer (WDM) 24 and an optical wavelength-division multiplexer (WDM) 26 which respectively optically multiplexes the pump light of the LD unit 32 input to the EDF 25, a second isolator 27 connected to the optical wavelength-division multiplexer 26, an optical wavelength division-multiplexer (coupler) 28 connected to the second isolator 27 to branch signal light to the output side and the monitor side, an optical output connector 29 which outputs a light signal output from the coupler 28, a photodetector (PD) 31 which monitors the level of the signal light branched by the coupler 28, an optical attenuation module (ATT) 30 connected between the PD 31 and the coupler 28, and a control circuit 33 for controlling the LD unit 32 in accordance with a monitor photocurrent of the PD 31.

The LD unit 32 is constituted by a plurality of semiconductor laser devices (LDs) which respectively output a laser beam having a wavelength corresponding to the wavelength of pump light and an optical wavelength-division multiplexer which multiplexes laser beams of different wavelengths output from the LDs. It is also allowed that the LD unit 32 is provided with a single LD and a branching unit which branches a laser beam output from the LD. The optical attenuation module 30 uses any one of the optical attenuation modules described in the above first to third embodiments. The optical wavelength-division multiplexers 24 and 26 respectively use a unit which multiplexes the pump light having a wavelength of 1,480 nm and the signal light having a wavelength of 1,550 nm.

In FIG. 20, the signal light input to the input connector 22 such as the signal light having a wavelength of 1,550 nm is input to the EDF 25 through the first isolator 23 and optical wavelength-division multiplexer 24. However, the pump light having a wavelength of 1,480 nm output from the LD unit 32 is input to the EDF 25 through the optical wavelength-division multiplexers 24 and 26 to excite erbium atoms in the EDF 25. In this instance, when the signal light having a wavelength of 1,550 nm is input to the EDF 25, induced emission occurs and thereby, the signal light having the wavelength of 1,550 nm is optically amplified. The amplified signal light having the wavelength of 1,550 nm is output from the output connector 29 after passing through the optical wavelength-division multiplexer 26, second isolator 27, and coupler 28.

The EDFA shown in FIG. 20 is the type of outputting up to 25 dBm when input-signal power is 0 dBm at wavelength of 1,550 nm. The coupler 28 uses such a one having a branch-port attenuation of 18 dBm. Moreover, the optical attenuation module 30 uses such a one in which an optical fiber is fusion spliced with fiber displacement so that a light attenuation becomes 5 dB. However, it is also allowed to use any one of the optical attenuation modules described in the above first to third embodiments. With the PD 31, the maximum photo-detection level is 5 dBm as a result of an experiment. When the optical attenuation module 30 is not used, the maximum level of the light input to the PD 31 becomes 7 dBm which exceeds the maximum photo-detection level of the PD 31. In this instance, because an original light output cannot be monitored and therefore, the PD 31 may be broken. To prevent the PD 31 from breaking, the optical attenuation module 30 is connected between the coupler 28 and the PD 31. In this instance, the maximum level to be input to the PD 31 becomes 2 dBm and thus, it is possible to keep within the maximum photo-detection level of the PD 31. Moreover, because any one of the optical attenuation modules described in the above first to third embodiments is used, the thermal load is dispersed and thermal breakdown is further prevented.

Moreover, it is also allowed to constitute the optical attenuation module 30 as not only any one of the optical attenuation modules described in the first to third embodiments but also an optical attenuation module using only one optical attenuator instead of using the optical attenuators 3-1 to 3-n. This is because a functional advantage is obtained that it is possible to raise the apparent maximum photo-detection level of the PD 31 by providing the optical attenuation module 30.

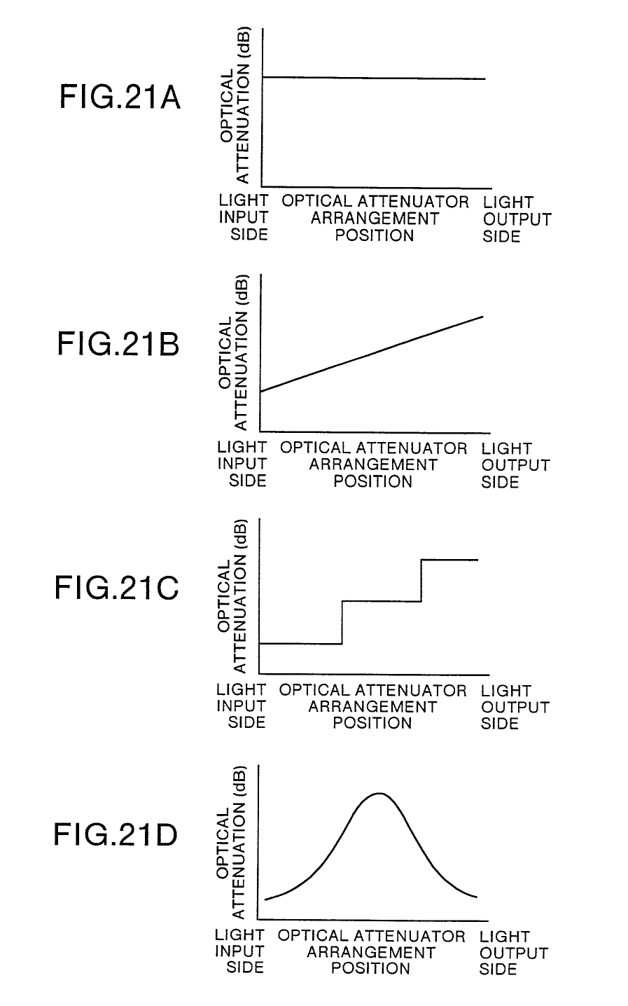

Furthermore, when cascade-connecting the optical attenuators 3-1 to 3-n, light attenuations of the optical attenuators 3-1 to 3-n are equal to those described in the first to third embodiments. However, it is also allowed to make light attenuations constant as shown in FIG. 21A or successively increase light attenuations from the light input side toward the light output side as shown in FIGS. 21B and 21C and as described in the first to third embodiments. In this instance, it is also allowed to continuously increase light attenuations as shown in FIG. 21B or stepwise increase them as shown in FIG. 21C. Furthermore, it is allowed to maximize the light attenuation of an optical attenuator set in the middle of cascade-connected optical attenuators and set light attenuations so as to successively decrease toward the optical attenuators at the both ends of the cascade-connected optical attenuators as shown in FIG. 21D and described in the second embodiment.

A fifth embodiment of the present invention is described below. In the above forth embodiment, output light of an EDFA is monitored. In the fifth embodiment, however, an optical attenuation module is used for an EDFA having high power signal input when it is necessary to monitor the signal light input.

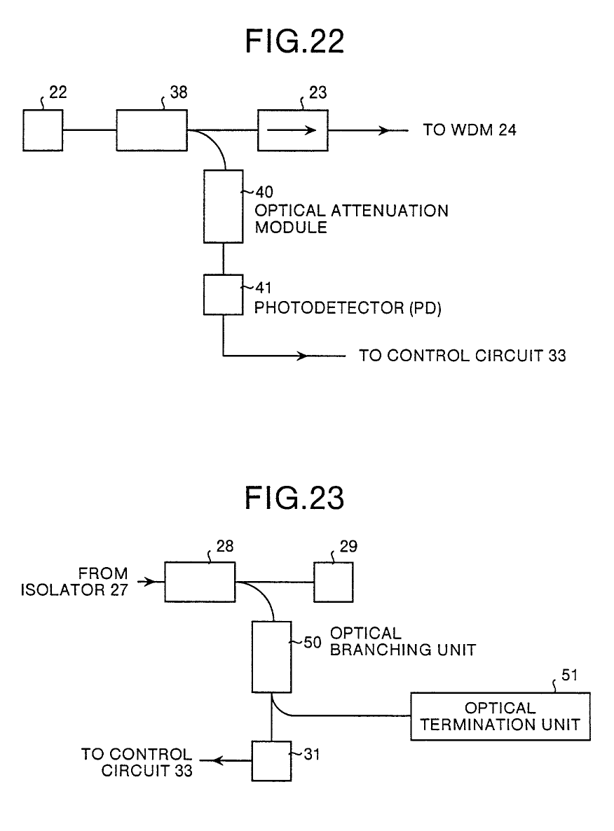

FIG. 22 is a block diagram which shows a part of a configuration of the optical amplifier which is the fifth embodiment of the present invention to which an optical attenuation module is applied. In FIG. 22, an optical wavelength-division multiplexer 38 is set between an input connector 22 and a first isolator 23, an optical attenuation module 40 is set between the optical wavelength-division multiplexer 38 and a PD 41, and the light level detected by the PD 41 is output to a control circuit 33. The optical attenuation module 40 has the same configuration as the optical attenuation module 30 described in the forth embodiment. Moreover, other configurations are the same as those of the forth embodiment.

In the fifth embodiment, the photo-detection allowable maximum level of the PD 41 must be raised in order to monitor high power signal light. However, because input light is further attenuated by the optical attenuation module 40, it is possible to raise the apparent photo-detection level of the PD 41. Moreover, the thermal load is dispersed and thermal breakdown can be prevented because the optical attenuation module 40 is used similarly to the forth embodiment.

Sixth embodiment of the present invention is described below. In the above forth embodiment, branched output light is attenuated and monitored by the optical attenuation module 30. In the sixth embodiment, however, branched output light is attenuated by an optical wavelength-division multiplexer.

FIG. 23 is a block diagram which shows a part of a configuration of the optical amplifier which is the sixth embodiment of the present invention. In FIG. 23, the output light branched from an optical wavelength-division multiplexer (coupler) 28 is input to an optical branching unit (coupler) 50, some of the output light entered a PD 31 and some of the remaining output light is gone to an optical termination unit 51 and thereby it is terminated. In this instance, it is also allowed to use any one of the optical attenuation modules described for the above first to third embodiments as the optical termination unit 51. Moreover, it is allowed to connect the optical termination unit 51 to other monitoring port without terminating. Other configurations are the same as those of the forth embodiment.

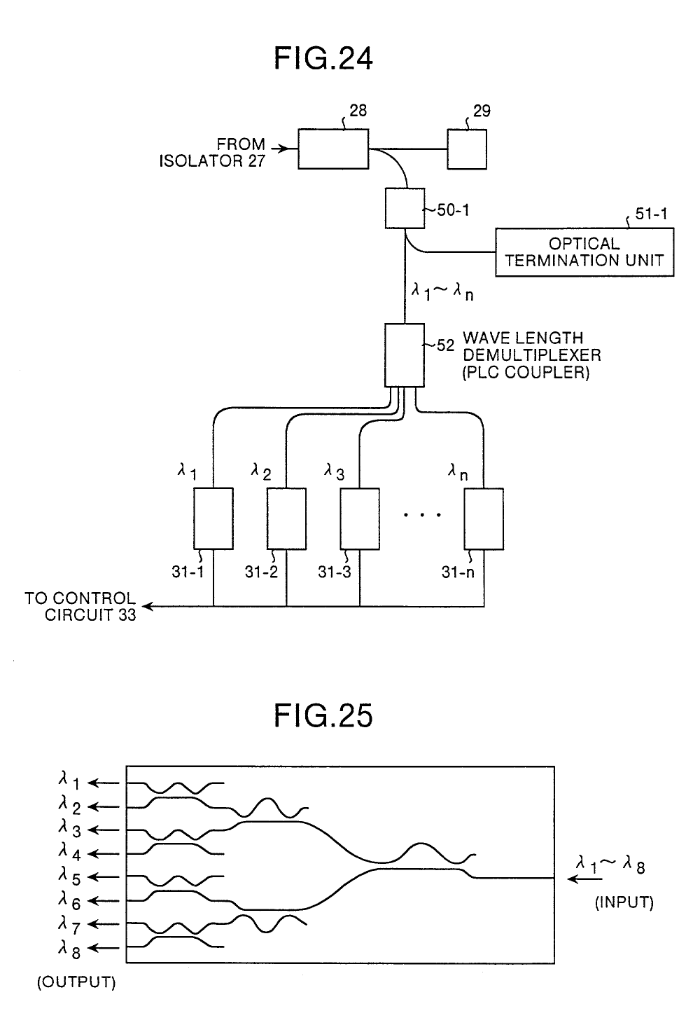

As shown in FIG. 24, PD 31-1 to PD 31-n for a plurality of wavelengths λ1 to λn may be provided in parallel in place of the PD 31, and a wavelength demultiplexer 52 shown in FIG. 24 may be provided between an optical branching unit (coupler) 50 and the PDs 31-1 to 31-n. By monitoring output for each of the wavelengths λ1 to λn, it is possible to control output of the a pump light source corresponding to each of the wavelengths λ1 to λn in the LD unit 31, which makes it possible to perform gain adjustment on the optical amplifier.

The wavelength demultiplexer 52 is realized by a planar lightwave circuit (PLC) coupler specifically shown in FIG. 25. FIG. 25 is a plan view of the PLC coupler. This PLC coupler comprises a plurality of Mach-Zehnder interferometers, and FIG. 25 shows a case where the input wavelength is demultiplexed into eight wavelengths (λ₁ to λ₈) using seven Mach-Zehnder interferometers.

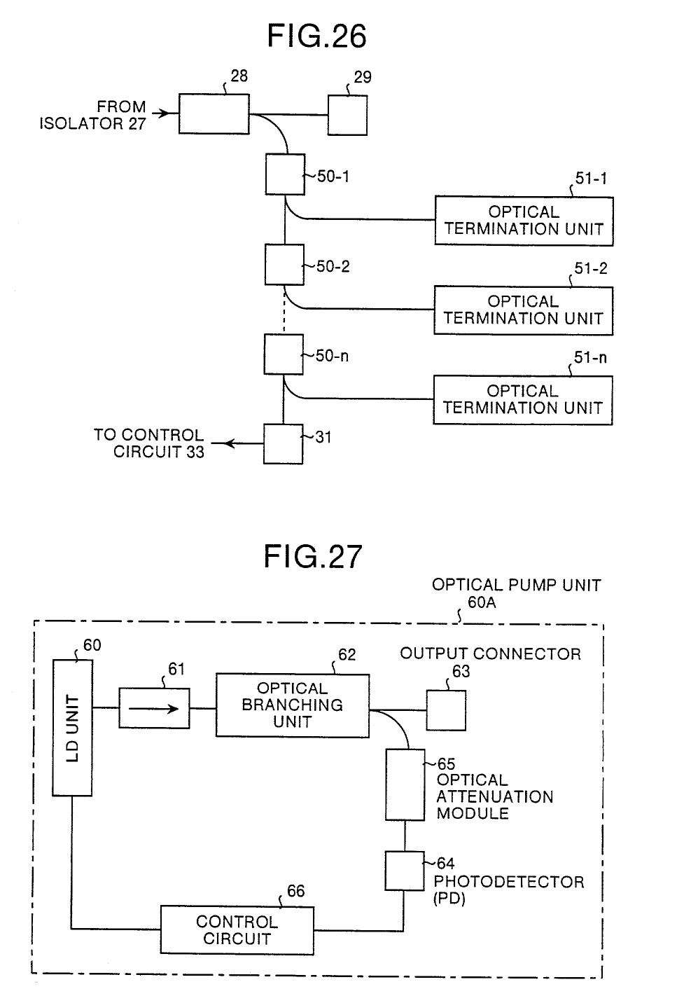

Furthermore, as shown in FIG. 26, it is allowed to combine the configuration of the above coupler 50 with that of the optical termination unit 51 in multistage. That is, in FIG. 26, couplers 50-1 to 50-n are successively connected in multistage and optical termination units 51-1 to 51-n are connected to branch ports of the couplers 50-1 to 50-n respectively. It is also allowed to connect the optical termination units 51-1 to 51-n to other monitoring ports instead of the branch ports. Moreover, it is allowed to make branch ratios of the couplers 50-1 to 50-n different from each other. Furthermore, it is allowed for light attenuations according to the branch ratios to have various attenuation distributions shown in FIGS. 21A to 21D.

In the sixth embodiment, when monitoring output light, the output light is attenuated by the coupler 50 and output to the PD 31. Therefore, it is possible to raise the apparent photo-detection level of the PD 31. Moreover, because the optical termination unit 51 uses any one of the optical attenuation modules described in the first to third embodiments, the thermal load of the optical termination unit 51 is dispersed and thermal breakdown can be prevented.

In the above forth to sixth embodiments, input signal light or amplified signal light is monitored. However, it is not so limited and it is also allowed to the light which is reflected from somewhere in optical transmission line to be branched by a tap coupler or an optical wavelength-division multiplexer, and to be attenuated by the above optical attenuation module to be monitored.

A seventh embodiment of the present invention is described below. The seventh embodiment of the present invention is a pump light source to which one of the optical attenuation modules described in the first to third embodiments is applied.

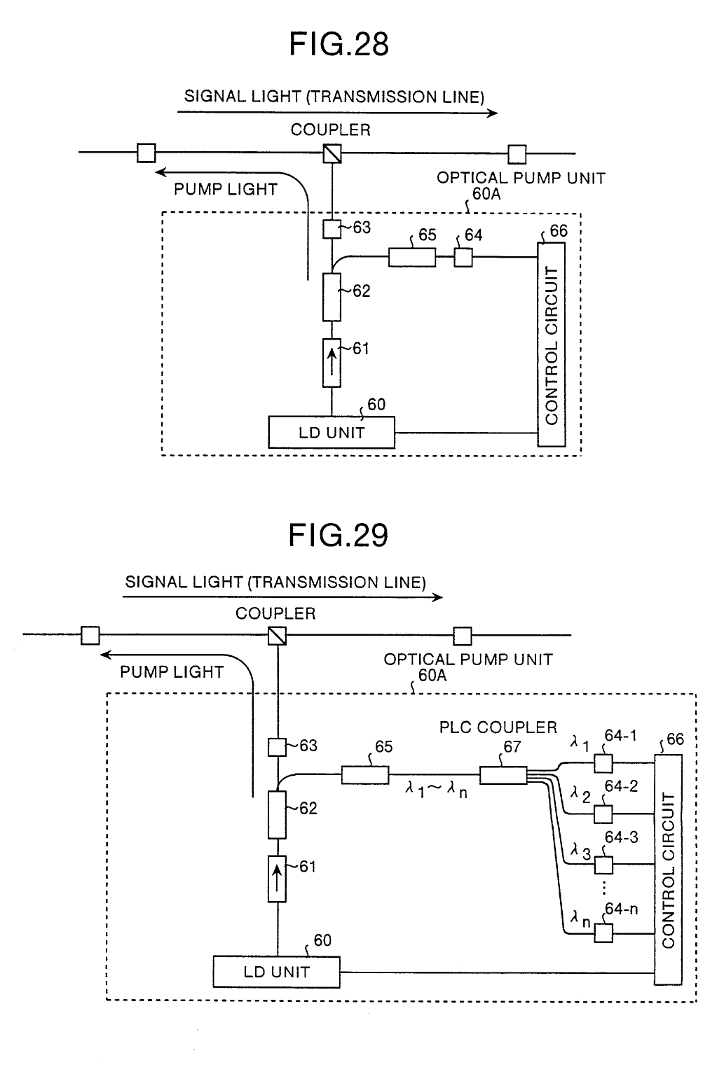

FIG. 27 is a block diagram which shows a configuration of the pump light source which is the seventh embodiment of the present invention. In FIG. 27, an optical pump unit 60A serving as the pump light source has an LD unit 60, an isolator 61 which intercepts return light due to reflection of light, an optical branching unit (coupler) 62 which branches the output light of the optical pump unit 60A to the output side and the monitoring side, an output connector 63 which outputs pump light, a PD 64 which monitors a light output, an optical attenuation module 65 connected between the coupler 62 and the PD 64, and a control circuit 66 for controlling the LD unit 60 in accordance with the light level photo-detected by the PD 64 and outputs desired pump light from the output connector 63. The pump light is output from the output connector 63 to a signal-light transmission line through a coupler as shown in FIG. 28.

The LD unit 60 is constituted by a plurality of semiconductor laser devices (LDs) which respectively outputs a laser beam having a wavelength corresponding to the wavelength of the pump light and an optical wavelength-division multiplexer which multiplexes a plurality of laser beams having wavelengths different from each other output from the LDs. It is also allowed to be such a one provided with a single LD and a branching unit which branches a laser beam output from the LD.

In this instance, the optical pump unit 60A is a pump light source of the type of outputting up to 30 dBm. The unit 60A uses the coupler 62 having a branch-port attenuation of 18 dB. Moreover, the optical attenuation module 65 uses such a one in which an optical fiber is fusion spliced with fiber displacement so that the light attenuation becomes 10 dB. It is found that the PD 64 has a maximum photo-detection level of 5 dBm as a result of an experiment. When the optical attenuation module 65 is not used, the maximum level of the light input to the PD 64 becomes 12 dBm which exceeds the maximum photo-detection level of the PD 24. In this instance, an original light output cannot be monitored and the PD 64 may be broken. To prevent the PD 64 from breaking, the optical attenuation module 65 is set between the coupler 62 and the PD 64. In this instance, the maximum level to be input to the PD 64 is 2 dBm which can be kept within the maximum photo-detection level of the PD 64.

As shown in FIG. 29, PD 64-1 to PD 64-n for a plurality of wavelengths λ1 to λn may be provided in parallel in place of the PD 64, and a PLC coupler 67 shown in FIG. 25 may be provided between the optical attenuation module 65 and the PDs 64-1 to 64-n. By monitoring output for each of the wavelengths λ1 to λn, it is possible to control output of the pump light source approximately corresponding to each of the wavelengths λ1 to λn in the LD unit 60, which makes it possible to perform gain adjustment on the optical amplifier.

It is also allowed to constitute an optical attenuation module in multistage instead of the optical attenuation module 65 similarly to the optical amplifiers described in the forth to sixth embodiments. Moreover, it is allowed to form not only the attenuation distribution of the optical attenuation module but also various attenuation distributions of optical attenuation modules constituted in multistage shown in FIGS. 21A to 21D. Furthermore, it is allowed to perform attenuation by a tap coupler or an optical wavelength-division multiplexer instead of the optical attenuation module 65. Furthermore, it is allowed to constitute couplers in multistage so as to have various attenuation distributions. Furthermore, it is allowed to connect an optical termination unit to the branch port of a coupler and use an optical attenuation module as the optical termination unit.

The optical pump unit 60A is used for any one of the forward exciting system, backward exciting system, and bidirectional exciting system. Moreover, it is used for the optical amplifiers described in the above forth to sixth embodiments. In this instance, though a Raman amplifier is shown, it is not so limited and it can be used also for various types of optical-fiber amplifiers including an EDFA.

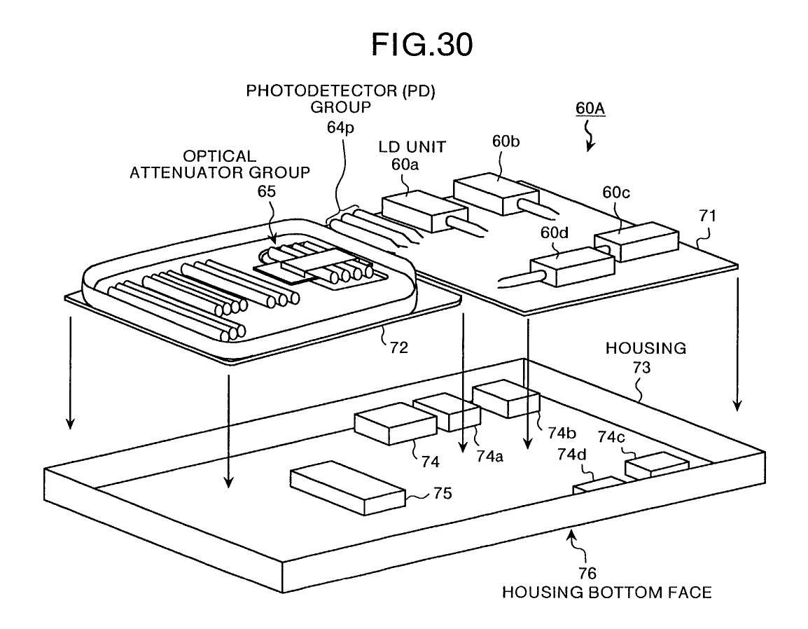

In this instance, the above-described optical pump unit 60A is formed into a module. FIG. 30 is an assembly-exploded view which shows a schematic arrangement in an optical pump unit. In FIG. 30, LD units 60a to 60d corresponding to the LD unit 60 and a photodetector group 64p corresponding to the photodetector 64 are arranged on a substrate 71. Moreover, an optical attenuator group 65 corresponding to the optical attenuation module 65 and other components including an isolator are arranged on a substrate 72. Though not illustrated in FIG. 30, an optical fiber and a control line which connects various portions are set to necessary places. The substrates 71 and 72 are fitted into a housing 73. In this instance, aluminum blocks 74a to 74d, 74 and 75 are formed at places corresponding to the LD units 60a to 60d and photodiode group 64p, and optical attenuator group 65 respectively in the housing 73. That is, an aluminum block is formed at a place corresponding to the arrangement of components serving as heat-producing sources to accelerate radiation to the housing 73 and provided with a function of a heat sink.

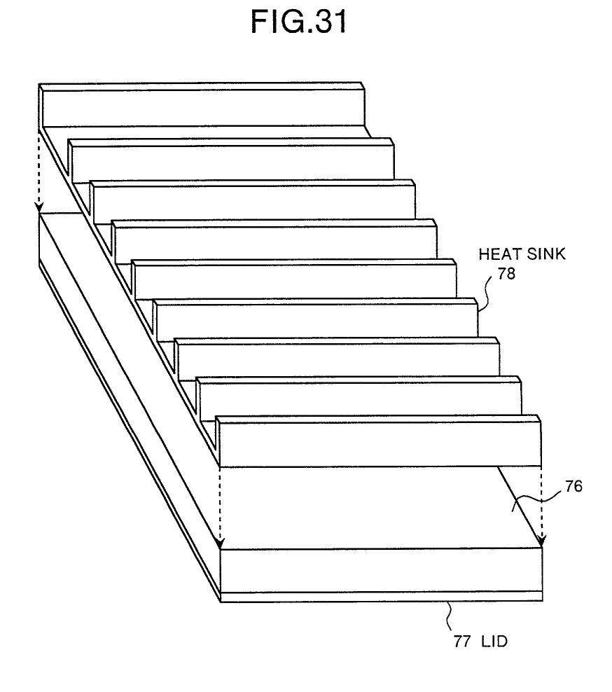

In FIG. 31, a heat sink 78 having fins is formed at the housing bottom face 76 side of the optical pump unit 60A assembled as shown in FIG. 30 to provide a natural-air-cooling function. Moreover, a lid 77 is set to the upper face of the housing73 and an inert gas is sealed in the housing 73. Thereby, it is possible to further improve the radiation effect, reduce thermal loads of the LD units 60a to 60d, photodetector group 64p, and optical attenuator group 65, and prevent thermal breakdown.

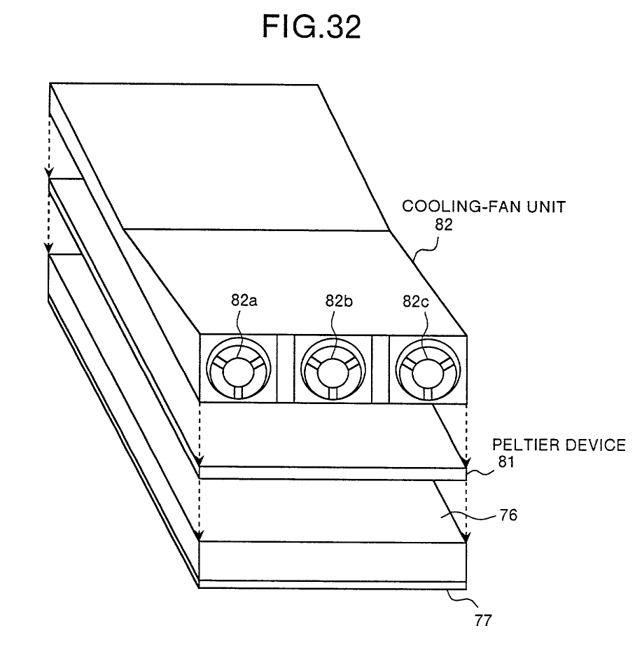

Moreover, in FIG. 32, a flat Peltier device 81 and a cooling-fan unit 82 having a plurality of fans 82a to 82c are set to the housing bottom face 76 side instead of the heat sink 78. The Peltier device 81 is set on the housing bottom face 76 and moreover, the cooling-fan unit 82 is set on the Peltier device 76. The Peltier device 81 is controlled polarization and the intensity of its electrical current by not-illustrated control circuit and power source to cool the housing 77. The cooling-fan unit 82 forcibly radiates extra heat that cannot be cooled by the Peltier device 81.

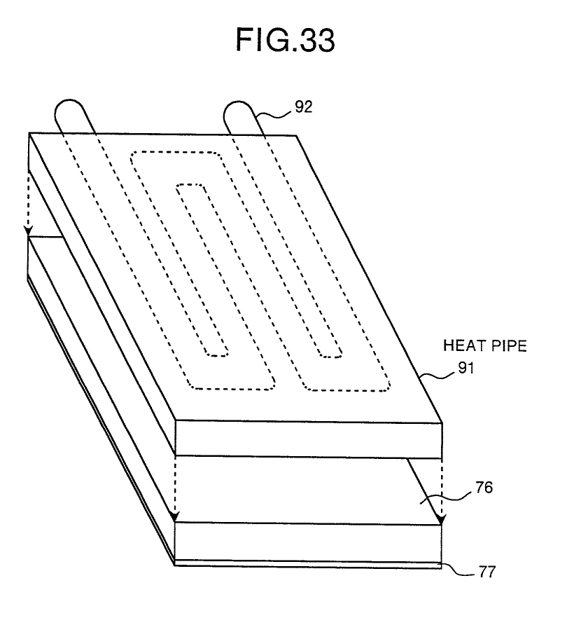

Furthermore, in FIG. 33, a heat pipe 91 is set on the housing bottom face 76 instead of the heat sink 78. In the heat pipe 91, a pipe 92 is meanderingly set by corresponding to the surface of the housing bottom face 76 so as to efficiently radiate heat with phase change of the liquid in the pipe. The pipe is provided with the air-cooling fin as shown in FIG. 15 at its one end and heat is radiated from the fin. It is allowed to apply other liquid-cooled system with water or coolant as the liquid circulating through the pipe 92.

In the seventh embodiment, the optical attenuation module 65 is set to attenuate monitoring light and then a PD photo-detects the monitoring light. Therefore, it is possible to lower the maximum photo-detection level of the PD and raise the apparent maximum photo-detection level of the PD. Moreover, because any one of the optical attenuation modules described in the first to third embodiments is used, thermal loads are dispersed and thermal breakdown can be prevented.

As described above, according to the present invention, an advantage can be obtained that it is possible to effectively prevent an optical attenuator from breaking when greatly attenuating high power light by reducing thermal loads of a plurality of optical attenuators connected in series and the whole optical attenuation module.

Moreover, because optical attenuations of a plurality of optical attenuators are set so that they are successively stepwise increased starting with optical attenuators at the both ends, maximized nearby the middle, and become symmetric between input and output ends, advantages are obtained that it is possible to eliminate the directivity to the light propagation direction, greatly improve the operability of the optical attenuators, almost equalize light consumption power of the optical attenuators to the light propagation direction, disperse thermal loads of the optical attenuators, and prevent the optical attenuators from breaking.

Moreover, because attenuations of optical attenuators are set by using an optical attenuation fiber, advantages are obtained that it is possible to accurately set fine light attenuations and further effectively perform thermal dispersion.

Furthermore, because optical attenuators are housed in a heat radiating case and cooled by an air-cooled unit or a liquid-cooled unit, advantages are obtained that it is possible to further prevent optical attenuators from breaking and realize an optical attenuation module having a high reliability.

Furthermore, according to the present invention, because an optical attenuation module is connected between an optical tap coupler and a photodetector, advantages are obtained that it is possible to improve the apparent maximum photo-detection level of the photodetector and monitor light output levels of a high power output amplifier and a pump light source.

Furthermore, because a pump light source is housed in a heat radiating case and moreover cooled by an air-cooled unit or liquid-cooled unit, advantages are obtained that it is possible to prevent a light source, an optical attenuator, and a photodetector from breaking and realize a high-reliability pump light source.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An optical attenuation module having a light input end and a light output end, wherein light input from the light input end is attenuated to a predetermined optical power and the attenuated light is output from the light output end, the optical attenuation module comprising:
a plurality of optical attenuators provided in between the light input end and the light output end, each of the optical attenuators attenuating the input light by a predetermined optical attenuation, and the optical attenuation of each of the optical attenuators being set to a value so that the optical attenuator is not damaged by light consumption power consumed within each of the optical attenuators.

2. The optical attenuation module according to claim 1, wherein the optical attenuators are connected in series in between the light input end and the light output end, and optical attenuations of the optical attenuators are set to values that successively increased from the optical attenuator provided near the light input end to the optical attenuator provided near the light output end.

3. The optical attenuation module according to claim 1, wherein light consumption power of the respective optical attenuators or light consumption power per unit length by the optical attenuators are almost equally set.

4. The optical attenuation module according to claim 1, wherein the plurality of optical attenuators or the optical attenuator are or is optical attenuation fibers or an optical attenuation fiber constituted by adding a light absorbing fiber to either or both of a core portion and a clad portion of an optical fiber.

5. The optical attenuation module according to claim 4, wherein the light absorbing fiber is an organic metallic compound containing one or more types of transition metal ions selected out of cobalt (Co),chromium (Cr), copper (Cu) zinc (Zn), lead (Pb), iron (Fe), aluminum (Al), nickel (Ni), manganese (Mn), and vanadium (V).

6. The optical attenuation module according to claim 4, wherein the light absorbent is a rare-earth element.

7. The optical attenuation module according to claim 4, wherein the same type of light absorbing fibers are added to the optical attenuation fibers and an optical attenuation is set in accordance with each length of the optical attenuation fibers.

8. The optical attenuation module according to claim 4, wherein the same type of light absorbing fibers are added to the optical attenuation fibers and an optical attenuation is set in accordance with a quantity of the absorbent to be added to the optical attenuation fibers.

9. The optical attenuation module according to claim 1, wherein the module is used as a termination unit which eliminates reflection of light.

10. The optical attenuation module according to claim 1, wherein the plurality of optical attenuators are housed in a heat radiating case.

11. The optical attenuation module according to claim 10, wherein an air-cooled unit having air-cooling fins is set to the heat radiating case.

12. The optical attenuation module according to claim 10, wherein a liquid-cooled unit using a heat pipe is set to the heat radiating case.

13. The optical attenuation module according to claim 10, wherein an air-cooled unit having an air-cooling fan is set to the heat radiating case.

14. The optical attenuation module according to claim 10, wherein an air-cooling hole is formed on the heat radiating case.

15. An optical attenuation module having a light input end and a light output end, wherein light input from the light input end is attenuated to a predetermined optical power and the attenuated light is output from the light output end, the optical attenuation module comprising:
an optical attenuator in which the optical attenuation per unit length is successively increased from the light input end toward the light output end.

16. The optical attenuation module according to claim 15, wherein light consumption power consumed by the respective optical attenuators or light consumption power per unit length of the optical attenuators are almost equally set.

17. The optical attenuation module according to claim 15, wherein the plurality of optical attenuators or the optical attenuator are or is optical attenuation fibers or an optical attenuation fiber constituted by adding a light absorbent to either or both of a core portion and a clad portion of an optical fiber.

18. The optical attenuation module according to claim 17, wherein the light absorbent is an organic metallic compound containing one or more types of transition metal ions selected out of cobalt (Co), chromium (Cr), copper (Cu), zinc (Zn), lead (Pb), iron (Fe), aluminum (Al), nickel (Ni), manganese (Mn), and vanadium (V).

19. The optical attenuation module according to claim 17, wherein the light absorbent is a rare-earth element.

20. The optical attenuation module according to claim 17, wherein the same type of light absorbing fibers are added to the optical attenuation fibers and an optical attenuation is set in accordance with each length of the optical attenuation fibers.

21. The optical attenuation module according to claim 17, wherein the same type of absorbents are added to the optical attenuation fibers and an optical attenuation is set in accordance with a dopant ratio of the optical attenuation fibers.

22. The optical attenuation module according to claim 15, wherein the module is used as a termination unit which eliminates reflection of light.

23. The optical attenuation module according to claim 15, wherein the optical attenuator is housed in a heat radiating case.

24. The optical attenuation module according to claim 23, wherein an air-cooled unit having air-cooling fins is set to the heat radiating case.

25. The optical attenuation module according to claim 23, wherein a liquid-cooled unit using a heat pipe is set to the heat radiating case.

26. The optical attenuation module according to claim 23, wherein an air-cooled unit having an air-cooling fan is set to the heat radiating case.

27. The optical attenuation module according to claim 23, wherein an air-cooling hole is formed on the heat radiating case.

28. An optical attenuation module having a pair of light input/output ends to apply predetermined attenuation to the light input from one of the light input/output ends and output the attenuated light from the other light input/output end, the optical attenuation module comprising:
a plurality of optical attenuators connected in series between the pair of light input/output ends, wherein
in the optical attenuator connected to the vicinity of the former light input/output end, an optical attenuation is set to a value relatively lower than that of the other serially connected optical attenuators.

29. The optical attenuation module according to claim 28, wherein bidirectional light consumption power consumed by the respective optical attenuators or light consumption power per unit length of the optical attenuators are almost equally set to the bidirectional light input/output between the pair of light input/output ends.

30. The optical attenuation module according to claim 28, wherein optical attenuations of the optical attenuators or an optical attenuation per unit length of the optical attenuators are substantially symmetrically set between the light input/output ends.

31. The optical attenuation module according to claim 28, wherein the plurality of optical attenuators or the optical attenuator are or is optical attenuation fibers or an optical attenuation fiber constituted by adding a light absorbing fiber to either or both of a core portion and a clad portion of an optical fiber.

32. The optical attenuation module according to claim 31, wherein the light absorbing fiber is an organic metallic compound containing one or more types of transition metal ions selected out of cobalt (Co), chromium (Cr), copper (Cu), zinc (Zn), lead (Pb), iron (Fe), aluminum (Al), nickel (Ni), manganese (Mn), and vanadium (V).

33. The optical attenuation module according to claim 31, wherein the light absorbing fiber is a rare-earth element.

34. The optical attenuation module according to claim 31, wherein the same type of absorbents are added to the optical attenuation fibers and an optical attenuation is set in accordance with each length of the optical attenuation fibers.

35. The optical attenuation module according to claim 31, wherein the same type of absorbents are added to the optical attenuation fibers and an optical attenuation is set in accordance with a dopant ratio of the optical attenuation fibers.

36. The optical attenuation module according to claim 28, wherein the module is used as a termination unit which eliminates reflection of light.

37. The optical attenuation module according to claim 28, wherein the plurality of optical attenuators are housed in a heat radiating case.

38. The optical attenuation module according to claim 37, wherein an air-cooled unit having air-cooling fins is set to the heat radiating case.

39. The optical attenuation module according to claim 37, wherein a liquid-cooled unit using a heat pipe is set to the heat radiating case.

40. The optical attenuation module according to claim 37, wherein the heat radiating case.

41. The optical attenuation module according to claim 37, wherein an air-cooling hole is formed on the heat radiating case.

42. An optical attenuation module having a pair of light input/output ends to apply predetermined attenuation to the light input from one of the light input/output ends and output the attenuated light from the other light input/output end, the optical attenuation module comprising:
an optical attenuator in which an optical attenuation per unit length is successively increased from the former light input/output end up to the vicinity of the middle between the pair of light input/output ends and an optical attenuation per unit length is successively decreased from the vicinity of the middle up to the other light input/output end.

43. The optical attenuation module according to claim 42, wherein bidirectional light consumption power of the respective optical attenuators or light consumption power per unit length by the optical attenuators are almost equally set to the bidirectional light input/output between the pair of light input/output ends.

44. The optical attenuation module according to claim 42, wherein optical attenuations of the optical attenuators or an optical attenuation per unit length of the optical attenuators are substantially symmetrically set between the light input/output ends.

45. The optical attenuation module according to claim 42, wherein the plurality of optical attenuators or the optical attenuator are or is optical attenuation fibers or an optical attenuation fiber constituted by adding a light absorbing fiber to either or both of a core portion and a clad portion of an optical fiber.

46. The optical attenuation module according to claim 45, wherein the light absorbent is an organic metallic compound containing one or more types of transition metal ions selected out of cobalt (Co), chromium (Cr), copper (Cu), zinc (Zn), lead (Pb), iron (Fe), aluminum (Al), nickel (Ni), manganese (Mn), and vanadium (V).

47. The optical attenuation module according to claim 45, wherein the light absorbent is a rare-earth element.

48. The optical attenuation module according to claim 45, wherein the same type of absorbents are added to the optical attenuation fibers and an optical attenuation is set in accordance with each length of the optical attenuation fibers.

49. The optical attenuation module according to claim 45, wherein the same type of absorbents are added to the optical attenuation fibers and an optical attenuation is set in accordance with a quantity of the absorbent to be added to the optical attenuation fibers.

50. The optical attenuation module according to claim 42, wherein the module is used as a termination unit which eliminates reflection of light.

51. The optical attenuation module according to claim 42, wherein the plurality of optical attenuators are housed in a heat radiating case.

52. The optical attenuation module according to claim 51, wherein an air-cooled unit having air-cooling fins is set to the heat radiating case.

53. The optical attenuation module according to claim 51, wherein a liquid-cooled unit using a heat pipe is set to the heat radiating case.

54. The optical attenuation module according to claim 51, wherein an air-cooled unit having an air-cooling fan is set to the heat radiating case.

55. The optical attenuation module according to claim 51, wherein an air-cooling hole is formed on the heat radiating case.

56. An optical amplifier comprising:
a pump light source; an amplifying optical fiber; a control circuit; a light-monitoring optical branching unit; a light-monitoring photodetector; and
an optical attenuator provided between the optical branching unit and the photodetector.

57. The optical amplifier according to claim 56, wherein the optical attenuator is the optical attenuation module having a light input end and a light output end, wherein light input from the light input end is attenuated to a predetermined optical power and the attenuated light is output from the light output end, the optical attenuation module comprising:
a plurality of optical attenuators are provided in between the light input end and the light output end, each of the optical attenuator attenuating the input light by a predetermined optical attenuation, the optical attenuation of each of the optical attenuators is set to a value so that the optical attenuator is not damaged by the input light consumption power.

58. The optical amplifier according to claim 56, wherein the optical attenuator is the optical attenuation module having a light input end and a light output end, wherein light input from the light input end is attenuated to a predetermined optical power and the attenuated light is output from the light output end, the optical attenuation module comprising:
an optical attenuator in which the optical attenuation per unit length is successively increased from the light input end toward the light output end.

59. The optical amplifier according to claim 56, wherein the optical attenuator is the optical attenuation module having a pair of light input/output ends to apply predetermined attenuation to the light input from one of the light input/output ends and output the attenuated light from the other light input/output end, the optical attenuation module comprising:
a plurality of optical attenuators connected in series between the pair of light input/output ends, wherein
in the optical attenuator connected to the vicinity of the former light input/output end, an optical attenuation is set to a value relatively lower than that of the other serially connected optical attenuators.

60. The optical amplifier according to claim 56, wherein the optical attenuator is the optical attenuation module having a pair of light input/output ends to apply predetermined attenuation to the light input from one of the light input/output ends and output the attenuated light from the other light input/output end, the optical attenuation module comprising:
an optical attenuator in which an optical attenuation per unit length is successively increased from the former light input/output end up to the vicinity of the middle between the pair of light input/output ends and an optical attenuation per unit length is successively decreased from the vicinity of the middle up to the other light input/output end.

61. The optical amplifier according to claim 56, wherein the optical attenuator comprises at least one optical branching unit.

62. The optical amplifier according to claim 61, wherein one or any of the optical branching units is a wavelength demultiplexer including a PLC coupler.

63. The optical amplifier according to claim 61, wherein a branch port of the optical branching unit is a terminal port, and the terminal port is connected with the optical attenuation module.

64. A pump light source comprising:
a light source; a control circuit; a light-monitoring optical branching unit; a light-monitoring photodetector; and
an optical attenuator provided between the optical branching unit and the photodetector.

65. The pump light source according to claim 64, wherein the optical attenuator is the optical attenuation module having a light input end and a light output end, wherein light input from the light input end is attenuated to a predetermined optical power and the attenuated light is output from the light output end, the optical attenuation module comprising:
a plurality of optical attenuators are provided in between the light input end and the light output end, each of the optical attenuator attenuating the input light by a predetermined optical attenuation, the optical attenuation of each of the optical attenuators is set to a value so that the optical attenuator is not damaged by the input light consumption power.

66. The pump light source according to claim 64, wherein the optical attenuator is the optical attenuation module having a light input end and a light output end, wherein light input from the light input end is attenuated to a predetermined optical power and the attenuated light is output from the light output end, the optical attenuation module comprising:
an optical attenuator in which the optical attenuation per unit length is successively increased from the light input end toward the light output end.

67. The pump light source according to claim 64, wherein the optical attenuator is the optical attenuation module having a pair of light input/output ends to apply predetermined attenuation to the light input from one of the light input/output ends and output the attenuated light from the other light input/output end, the optical attenuation module comprising:
a plurality of optical attenuators connected in series between the pair of light input/output ends, wherein
in the optical attenuator connected to the vicinity of the former light input/output end, an optical attenuation is set to a value relatively lower than that of the other serially connected optical attenuators.

68. The pump light source according to claim 64, wherein the optical attenuator is the optical attenuation module having a pair of light input/output ends to apply predetermined attenuation to the light input from one of the light input/output ends and output the attenuated light from the other light input/output end, the optical attenuation module comprising:
an optical attenuator in which an optical attenuation per unit length is successively increased from the former light input/output end up to the vicinity of the middle between the pair of light input/output ends and an optical attenuation per unit length is successively decreased from the vicinity of the middle up to the other light input/output end.

69. The pump light source according to claim 64, wherein the optical attenuator comprises at least one optical branching unit.

70 The pump light source according to claim 69, wherein one or any of the optical branching units is a wavelength demultiplexer including a PLC coupler.

71. The pump light source according to claim 69, wherein a branch port of the optical branching unit is a terminal port, and the terminal port is connected with the optical attenuation module.

72. The pump light source according to claim 64, wherein at least the light source, the photodetector, and the optical attenuator are housed in a heat radiating case.

73. The pump light source according to claim 72, wherein the light source, the photodetector, and the optical attenuator are connected to a heat sink in the heat radiating case.

74. The pump light source according to claim 72, wherein an air-cooled unit having air-cooling fins is set to the heat radiating case.

75. The pump light source according to claim 72, wherein a liquid-cooled unit using a heat pipe is set to the heat radiating case.

76. The pump light source according to claim 72, wherein an air-cooled unit having an air-cooling fan is set to the heat radiating case.
